(19) United States
(12) Patent Application Publication
(10) Pub. No.: US 2018/0007585 A1
(43) Pub. Date: Jan. 4, 2018

(54) USER TERMINAL AND RADIO COMMUNICATION METHOD

(71) Applicant: NTT DOCOMO, INC., Tokyo (JP)

(72) Inventors: Kazuaki Takeda, Tokyo (JP); Shimpei Yasukawa, Tokyo (JP); Satoshi Nagata, Tokyo (JP); Hideyuki Moroga, Tokyo (JP); Liu Liu, Beijing (CN); Qin Mu, Beijing (CN)

(73) Assignee: NTT DOCOMO, INC., Tokyo (JP)

(21) Appl. No.: 15/543,657

(22) PCT Filed: Jan. 27, 2016
(86) PCT No.: PCT/JP2016/052227

§ 371 Date: Jul. 14, 2017

(30) Foreign Application Priority Data
Jan. 28, 2015 (JP) 2015-014607
Feb. 10, 2015 (JP) 2015-024613

(51) Int. Cl. H04W 28/18; H04W 72/04; H04W 4/00

(52) U.S. Cl. CPC H04W 28/18; H04W 72/042; H04W 4/005

(57) ABSTRACT

The present invention is designed so that broadcast information is transmitted and received adequately even when the bandwidth to use is limited to partial reduced bandwidths in a system bandwidth and the broadcast information is transmitted and received in repetitions over multiple subframes. A user terminal, in which the bandwidth to use is limited to a partial reduced bandwidth in a system bandwidth, has a receiving section that receives first system information and second system information, and a control section that acquires transmission information, which includes the repetition factor for the second system information, from the first system information, and the receiving section receives the second system information based on the transmission information.

### TECHNICAL FIELD

The present invention relates to a user terminal and a radio communication method in next-generation mobile communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). While the specifications of LTE-advanced have been already drafted for the purpose of achieving further broadbandization and higher speeds beyond LTE, in addition, for example, a successor system of LTE—referred to as “FRA” (Future Radio Access)—is under study.

Now, accompanying the cost reduction of communication devices in recent years, active development is in progress in the field of technology related to machine-to-machine communication (M2M) to implement automatic control of network-connected devices and allow these devices to communicate with each other without involving people. In particular, of all M2M, 3GPP (3rd Generation Partnership Project) is promoting standardization with respect to the optimization of MTC (Machine-Type Communication), as a cellular system for machine-to-machine communication (see non-patent literature 2). MTC terminals are being studied for use in a wide range of fields, such as, for example, electric meters, gas meters, vending machines, vehicles and other industrial equipment.

### CITATION LIST

### Non-Patent Literature

Non-Patent Literature 1: 3GPP TS 36.300 “Evolved Universal Terrestrial Radio Access (E-UTRA) and Evolved Universal Terrestrial Radio Access Network (E-UTRAN); Overall Description; Stage 2”

Non-Patent Literature 2: 3GPP TS 36.888 “Study on Provision of Low-Cost Machine-Type Communications (MTC) User Equipments (UEs) based on LTE (Release 12)”

### SUMMARY OF INVENTION

### Technical Problem

From the perspective of reducing the cost and improving the coverage area in cellular systems, amongst all MTC terminals, low-cost MTC terminals, which can be implemented in simple hardware structures, have been increasing in demand. Low-cost MTC terminals can be implemented by limiting the uplink bandwidth and the downlink bandwidth to use to part of a system bandwidth. A system bandwidth is equivalent to, for example, an existing LTE band (for example, 20 MHz), a component carrier and so on.

When the bandwidth to use is limited to part of a system bandwidth, the signals and channels used in existing systems cannot be received. For example, in existing systems, information that is needed in all terminals in a cell, such as operation parameters, is communicated as broadcast information. As radio resources for use for broadcast information, fixed resources for broadcast information such as the PBCH (Physical Broadcast CHannel) and resources that can be used in a variable fashion such as the PDSCH (Physical Downlink Shared CHannel) are combined and used.

However, user terminals (for example, MTC terminals), in which the bandwidth to use is limited to a portion of a system bandwidth, cannot receive existing system information blocks (SIBs) transmitted in the existing PDSCH.

Furthermore, given that the PDSCH suffers deteriorated receiving performance when the bandwidth to use is limited, a study is in progress to transmit SIBs over a plurality of subframes in order to achieve improved receiving performance. For example, by repeating transmitting the same signal over multiple subframes, it may be possible to improve the received-signal-to-interference/noise ratio (SINR: Signal-to-Interference plus Noise Ratio). However, if no information is available about the repetitions, there is a threat that a user terminal is unable to receive broadcast information, and, consequently, unable to communicate adequately.

The present invention has been made in view of the above, and it is therefore an object of the present invention to provide a user terminal and a radio communication method that allow adequate transmission and receipt of broadcast information even when the bandwidth to use is limited to partial reduced bandwidths in a system bandwidth and the broadcast information is transmitted and received in repetitions over multiple subframes.

### Solution to Problem

According to the present invention, a user terminal, in which the bandwidth to use is limited to partial reduced bandwidths in a system bandwidth, a receiving section that receives first system information and second system information, and a control section that acquires transmission information, which includes the repetition factor for the second system information, from the first system information, and the receiving section receives the second system information based on the transmission information.

### Advantageous Effects of Invention

According to the present invention, broadcast information can be transmitted and received adequately even when the bandwidth to use is limited to partial reduced bandwidths in a system bandwidth and broadcast information is transmitted and received in repetitions over multiple subframes.

### BRIEF DESCRIPTION OF DRAWINGS

FIG. 1 provide diagrams to explain the arrangement of predetermined frequency bandwidths in a system bandwidth on the downlink;

FIG. 2 is a diagram to explain the arrangement of predetermined frequency bandwidths in a system bandwidth on the downlink;

FIG. 3 is a diagram to show the allocation of radio resources in broadcast information transmission according to a first example;

FIG. 4 is a diagram to show the allocation of radio resources in broadcast information transmission according to the first example;

FIG. 5 is a diagram to show the allocation of radio resources in broadcast information transmission according to a second example;

FIG. 6 is a diagram to show a schematic structure of a radio communication system according to an embodiment of the present invention;

FIG. 7 is a diagram to show an example of an overall structure of a radio base station according to an embodiment of the present invention;

FIG. 8 is a diagram to show an example of a functional structure of a radio base station according to an embodiment of the present invention;

FIG. 9 is a diagram to show an example of an overall structure of a user terminal according to an embodiment of the present invention;

FIG. 10 is a diagram to show an example of a functional structure of a user terminal according to an embodiment of the present invention;

FIG. 11 is a diagram to explain repetition factors according to a third example;

FIG. 12 is a diagram to explain repetition factors according to the third example; and

FIG. 13 provide diagrams to explain repetition factors according to the third example.

### DESCRIPTION OF EMBODIMENTS

Now, an embodiment of the present invention will be described in detail below with reference to the accompanying drawings. In order to reduce the cost of MTC terminals, there are ongoing studies to lower the processing capabilities of terminals by lowering the peak rate, limiting the resource blocks, and allowing limited RF (Radio Frequency) reception. For example, the following limitations are under study in order to reduce the cost of MTC terminals. The maximum transport block size in unicast transmission using a physical downlink shared channel (PDSCH) may be limited to 1000 bits. The maximum transport block size in BCCH (Broadcast Control CHannel) transmission using the PDSCH may be limited to 2216 bits. The downlink data channel bandwidth may be limited to 6 resource blocks (PRBs (Physical Resource Blocks)). The RFs to receive in MTC terminals may be limited to one.

The transport block size and the resource blocks in low-cost MTC terminals are more limited than in existing user terminals, and therefore low-cost MTC terminals cannot connect with cells in compliance with LTE Rel. 8 to 11. Low-cost MTC terminals connect only with cells where a permission of access is reported to the low-cost MTC terminals in broadcast signals.

For MTC terminals, a study is in progress to limit not only downlink data signals, but also various control signals that are transmitted on the downlink, such as system information and downlink control signals, as well as data signals and various control signals that are transmitted on the uplink, to predetermined reduced bandwidths (for example, 1.4 MHz).

In this way, MTC terminals need to be operated in an LTE system bandwidth, considering the relationship with existing user terminals. Here, MTC terminals refer to terminals, in which the bandwidth to use is limited to partial reduced bandwidths (for example, 1.4 MHz) in a system bandwidth. Existing user terminals refer to terminals, in which the system bandwidth (for example, 20 MHz) is the bandwidth to use. In a system bandwidth, frequency-multiplexing of MTC terminals and existing user terminals is supported. MTC terminals support only RFs of predetermined reduced bandwidth in the uplink and the downlink.

IN this way, the bandwidth for use for MTC terminals is limited to reduced bandwidths, and the bandwidth for use by existing terminals is configured to the system bandwidth. Since MTC terminals are designed based on reduced bandwidths, they have simplified hardware structures, and their processing capabilities are more limited than existing user terminals. MTC terminals may be referred to as “LC-MTC” (low cost MTC or low complexity MTC), “MTC UEs,” and so on. Existing user terminals may be referred to as “normal UEs,” “non-MTC UEs,” “category 1 UEs” and so on.

There are three requirements for MTC terminals according to LTE Rel. 13—namely, reduced complexity, coverage enhancement, and reduced power consumption. For coverage enhancement, coverage enhancement of 15 dB or more is required in comparison to category 1. For the reduction of power consumption, there is a demand to make the battery life longer.

As mentioned earlier, the bandwidth for use for MTC terminals is limited to reduced bandwidth (for example, 1.4 MHz) for the purpose of reducing the complexity and reducing the cost. Considering the application of traffic offloading and frequency hopping over an existing LTE bandwidth (for example, 20 MHz), MTC terminals are provided with RF retuning functions.

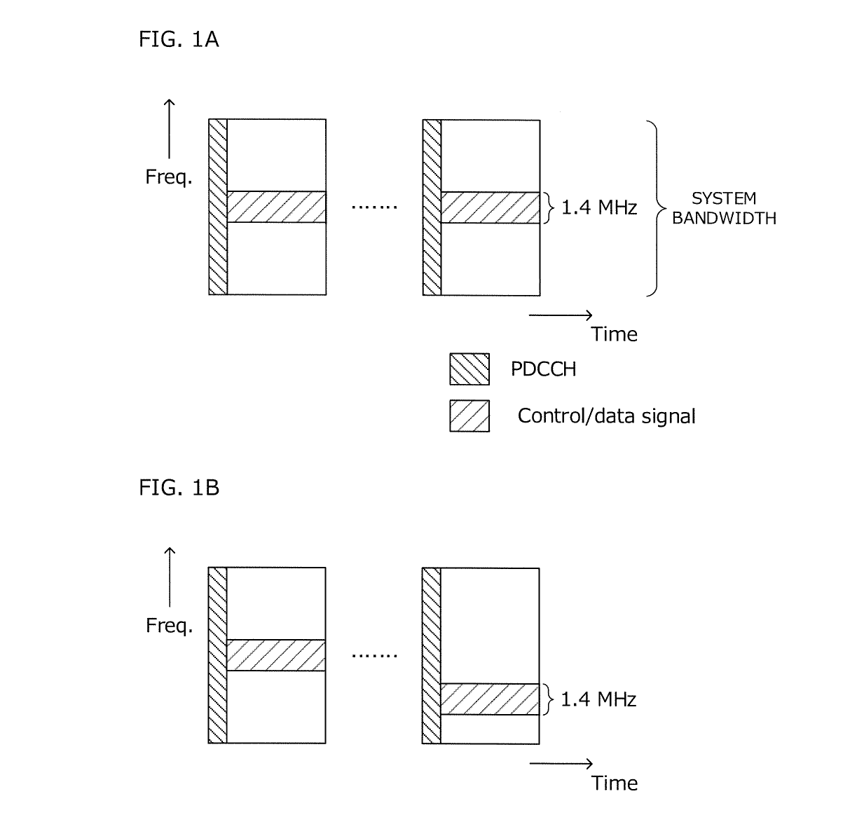

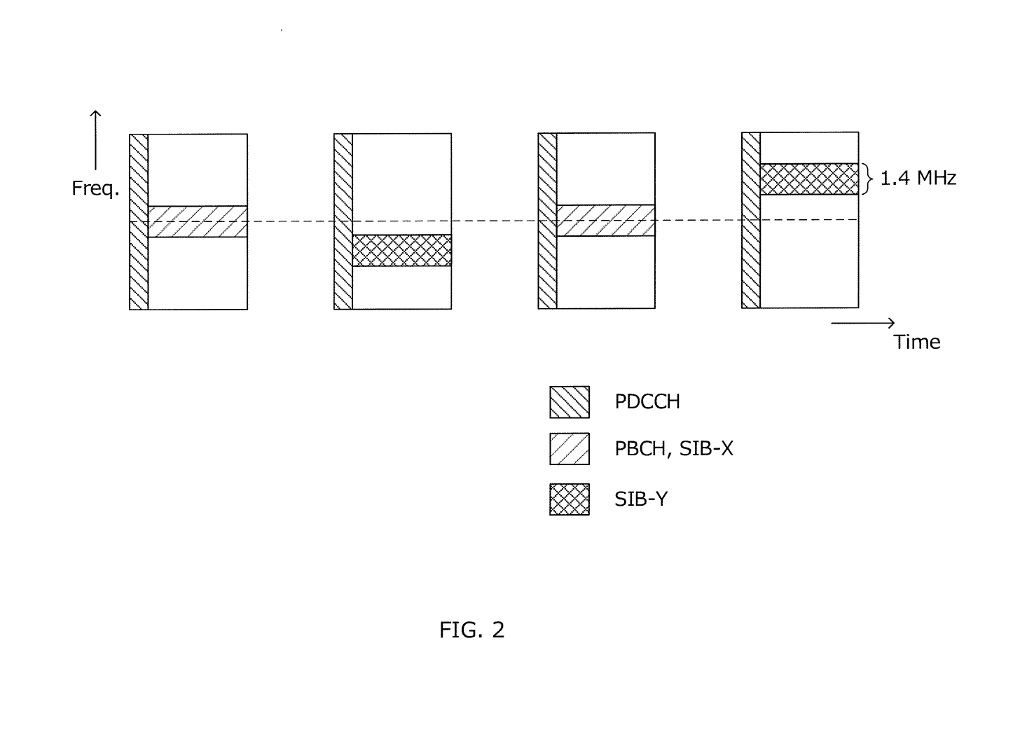

Now, the arrangement of predetermined frequency bandwidths in a downlink system bandwidth will be described with reference to FIG. 1 and FIG. 2.

In the examples shown in FIG. 1, the bandwidth for use for MTC terminals is limited to a partial frequency bandwidth (for example, 1.4 MHz) in a system bandwidth. In the example shown in FIG. 1A, the location of the 1.4-MHz frequency bandwidth is fixed over a plurality of subframes. In this case, no frequency diversity effect can be achieved, and therefore there is a threat the spectral efficiency might decrease. Also, the problem arises that the traffic of MTC terminals concentrates in the center frequency. In the example shown in FIG. 1B, the 1.4-MHz frequency bandwidth changes its location per subframe, and is variable. In this case, a frequency diversity effect is achieved, so that it is possible to reduce the decrease of spectral efficiency. Furthermore, the traffic of MTC terminals can be dispersed.

When, as shown in FIG. 2, broadcast information is transmitted by changing the location of a predetermined frequency bandwidth on a per subframe basis, a physical broadcast channel (PBCH) is transmitted in the center 1.4-MHz of a subframe. As for the system information blocks (SIBs), given that MTC terminals can only receive in 6 resource blocks, which is insufficient for transmitting broadcast information, and cannot read the common search space (C-SS) in a physical downlink control channel (PDCCH), new SIBs, including ones that support coverage enhancement mode and ones that do not, are set forth for dedicated use for MTC terminals. The new SIBs for dedicated use for MTC terminals will be hereinafter referred to as “MTC-SIBs” or “M-SIBs.”

It is likely that repetition needs to be applied to M-SIBs depending on the number of transmitting bits, the coverage and so on. Repetition refers to the act of repeating transmitting the same PDSCH by using a plurality of subframes. An MTC terminal can combine the PDSCHs transmitted in a plurality of subframes, and implement efficient PDSCH decoding. Note that repetitions may be made in the same frequency resources, or may be made by hopping to different frequency resources on a per subframe basis.

How the repetition factor should be configured in repetition is not clear. For example, there is a threat making the repetition factor too large leads to lower spectral efficiency, and making the repetition factor too small leads to insufficient coverage. Consequently, the repetition factor should not be fixed, and should more preferably be controlled dynamically so that the repetition factor can be changed per cell.

To meet this, the present inventors have found out a method for dynamically controlling the repetition factor of system information on a per cell basis. According to this method, it is possible to maximize the spectral efficiency in each cell size, and, furthermore, reduce the power consumption of MTC terminals.

Although, in the following description, MTC terminals will be shown as an example of user terminals in which the bandwidth to use is limited to reduced bandwidths, the application of the present invention is not limited to MTC terminals. Furthermore, although 6-PRB (1.4-MHz) reduced bandwidths will be described below, the present invention can be applied to other reduced bandwidths as well, based on the present description.

### First Example

With the first example, the M-SIB transmission methods for when a common search space is defined, and for when no such common search space is defined, in an EPDCCH, will be described.

As shown in FIG. 1, MTC terminals support only predetermined reduced bandwidths (1.4 MHz), and therefore cannot detect the downlink control information (DCI) that is transmitted in the wide-bandwidth PDCCH. So, it may be possible to allocate downlink (PDCCH) and uplink (PUSCH: Physical Uplink Shared CHannel) resources to MTC terminals by using an enhanced PDCCH (EPDCCH: Enhanced PDCCH).

The EPDCCH is formed with enhanced control channel elements (ECCEs), and the user terminals acquire downlink control signals by monitoring (blind-decoding) the search spaces. As for the search spaces, a UE-specific search space (U-SS), which is configured individually for each user terminal, and a common search space (C-SS), which is configured to be shared by each user terminal, can be configured. The search spaces to configure in an enhanced control channel may be designed so that a UE-specific search space alone is configured, without configuring a common search space, or a common search space and a UE-specific search space are both configured.

First, the case where no common search space is defined in an EPDCCH will be described. M-SIB1 is transmitted in a pre-defined cycle, by using 6 PRBs in the center of a subframe. The repetition factor of M-SIB1 is fixed depending on the cell coverage. The repetition factor of M-SIB1 may be determined in the specification, or may be derived from the PBCH. Information for subsequent M-SIBs (hereinafter referred to as “M-SIBx”) such as scheduling information, the SI (system information) window length, the repetition factor, the MCS (modulation and coding scheme) and information related to frequency hopping and so on is included in M-SIB1. Alternatively, some of the above information may be associated with M-SIB1. This association means that, for example, assuming that the repetition factor for M-SIBx is the same as or twice that of M-SIB1, the repetition factor for M-SIBx is implicitly derived from the repetition factor of M-SIB1.

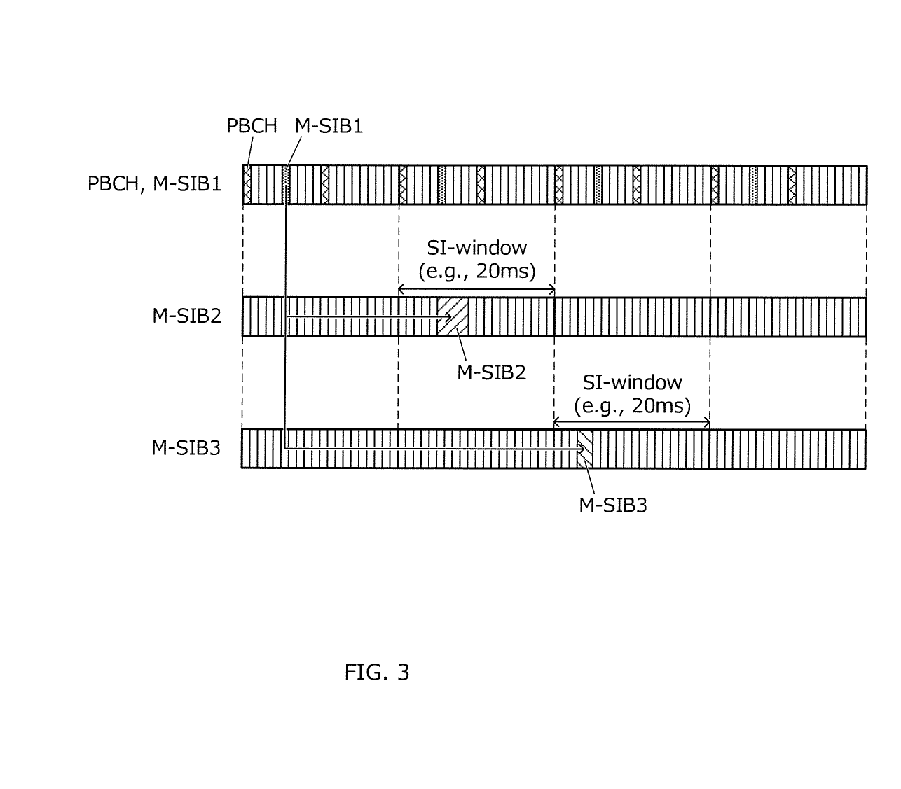

FIG. 3 shows the allocation of radio resources in broadcast information transmission when no common search space is defined in an EPDCCH. In the example shown in FIG. 3, the PBCH, which is a fixed broadcast information resource, is transmitted in a 10-ms cycle. An MTC terminal first receives the PBCH, which is a fixed resource, acquires the minimal information that is required to receive the PDSCH, from the PBCH, and, based on this information, reads the broadcast information transmitted in the PDSCH. For example, the PBCH reports the repetition factor of M-SIB1 to the MTC terminal.

In the example shown in FIG. 3, M-SIB1 is transmitted in a 20-ms cycle. In M-SIB1, the scheduling information of M-SIBx is transmitted. Although M-SIBx (in FIG. 3, M-SIB2 and M-SIB3) are illustrated to be transmitted in a consecutive manner here, they may be transmitted in discontinuous repetitions, or may be transmitted in repetition patterns that are reported. In the example shown in FIG. 3, the SI window length of the M-SIBx is configured to 20 ms.

In this way, an MTC terminal becomes capable of receiving M-SIB1 upon receiving the PBCH, which is a fixed resource. The repetition factor of M-SIB1 may be reported in the PBCH, or may be provided in the specification in advance. The MTC terminal receives M-SIB1 and acquires the scheduling information of M-SIBx from M-SIB1, thereupon becoming capable of receiving M-SIBx. The repetition factor for M-SIBx is reported in M-SIB1, or may be derived implicitly from the repetition factor of M-SIB1.

Next, the case where no common search space is defined in an EPDCCH will be described. In this case, a radio base station maps shared control information, which is to be shared between MTC terminals, in the common search space of the EPDCCH. Based on the shared control information, which is acquired by blind-decoding the EPDCCH, an MTC terminal receives the M-SIB allocated to the PDSCH.

M-SIB1 may be transmitted in fixed timings. All the information for transmitting M-SIB1, including the repetition factor, is defined in advance. That is, M-SIB1 is transmitted using fixed resources. These pieces of information are available to the radio base station and MTC terminals in advance.

M-SIB1 may be transmitted dynamically by using the common search space. In this case, the number of M-SIB1 bits may be made variable. Only the subframe for monitoring the common search space of M-SIB1 is determined in advance. The repetition factor for the subframe for monitoring the M-SIB1 common search space is fixed. Additional information such as the repetition factor, the MCS, information related to frequency hopping, and suchlike information for M-SIB1 to be transmitted in the PDSCH may be represented by DCI (Downlink Control Information) format 1A/1C scrambled by an SI-RNTI (System Information-Radio Network Temporary Identifier). For example, new fields may be set forth, or existing fields (for example, the resource assignment field) may be replaced, in the DCI format, in order to indicate these additional pieces of information.

The scheduling information, the SI window length and suchlike information for M-SIBx is included in M-SIB1. Additional information such as the repetition factor, the MCS, information related to frequency hopping and suchlike information for M-SIBx to be transmitted in the PDSCH may be represented by DCI format 1A/1C scrambled by an SI-RNTI. The repetition factor for the common search space-monitoring subframe may be fixed, may be included in M-SIB1, or may be associated with M-SIB1. For example, new fields may be set forth, or existing fields (for example, the resource assignment field) may be replaced, in the DCI format, in order to indicate these additional pieces of information.

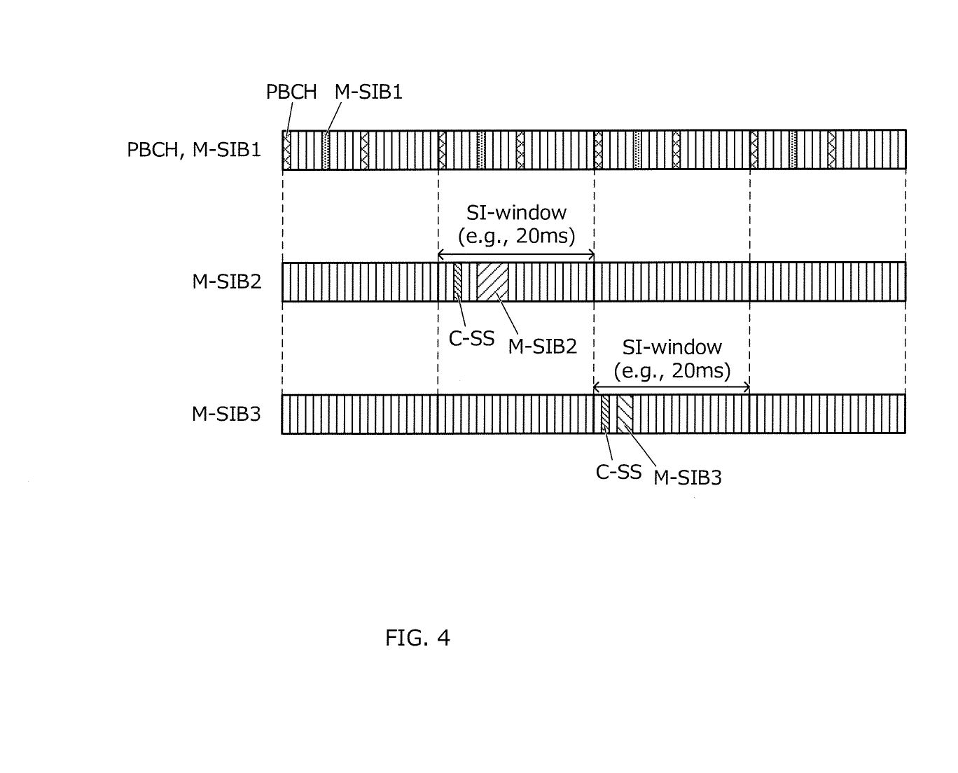

FIG. 4 shows the allocation of radio resources in broadcast information transmission when a common search space is defined in an EPDCCH. In FIG. 4, M-SIB1 may be transmitted in fixed timings, as mentioned earlier, or dynamic scheduling may be applied thereto. An MTC terminal receives M-SIB1 allocated to the PDSCH, based on the common control information allocated in the common search space of the EPDCCH. M-SIB1 contains the scheduling information for M-SIBx and suchlike information.

The MTC terminal receives M-SIBx allocated to the PDSCH, based on the common control information allocated in the common search space of the EPDCCH. The repetition factor for the common search space-monitoring subframe may be fixed, may be included in M-SIB1, or may be associated with M-SIB1. Although M-SIBx are illustrated to be transmitted in a consecutive manner in FIG. 4, they may be transmitted in discontinuous repetitions, or may be transmitted in repetition patterns that are reported.

### Second Example

An M-SIB transmission method that is different from that of the first example will be described with a second example.

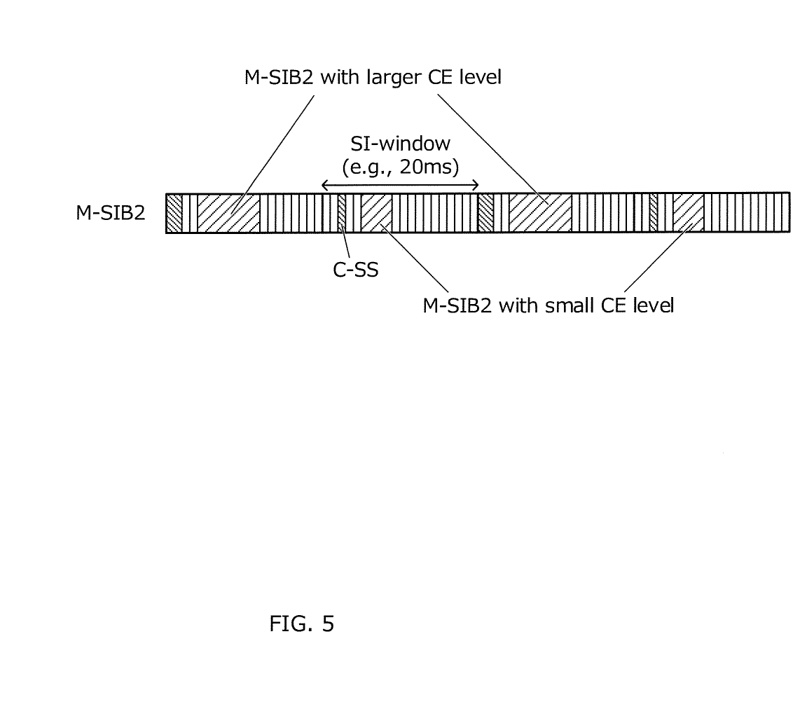

In this method, the same M-SIBx, having different repetition factors, is transmitted (see FIG. 5). In the example shown in FIG. 5, M-SIB2 of a large repetition factor and M-SIB2 of a small repetition factor are transmitted alternately, per predetermined cycle (in FIG. 5, one cycle is 20 ms). The M-SIBx transmission pattern is transmitted in M-SIB1.

In the example shown in FIG. 5, an EPDCCH common search space for receiving M-SIB2 is defined, and the repetition factor for the subframe for monitoring the common search space varies per cycle. The repetition factor for the common search space-monitoring subframe may be fixed, may be included in M-SIB1, or may be associated with M-SIB1. Also, it is equally possible not to define the common search space.

An MTC terminal decides whether to receive M-SIBx of a large coverage enhancement (CE) level—that is, a large repetition factor—or to receive M-SIBx of a small CE level—that is, a small repetition factor—based on, for example, the RSRP (Reference Signal Received Power) measurement results.

By this means, an MTC terminal can adequately receive M-SIBx based on the relationship between the locations of the radio base station and the MTC terminal, the received quality in the MTC terminal, and so on.

### Third Example

The repetition factor of M-SIBs will be explained with a third example. When the repetition factor is large, a time diversity effect is gained, and therefore good performance is achieved. However, when the repetition factor is larger, the modification period becomes longer, and an MTC terminal takes a longer time to receive M-SIBs, which then leads to a delay. That is, a tradeoff relationship holds between the repetition factor and the modification period.

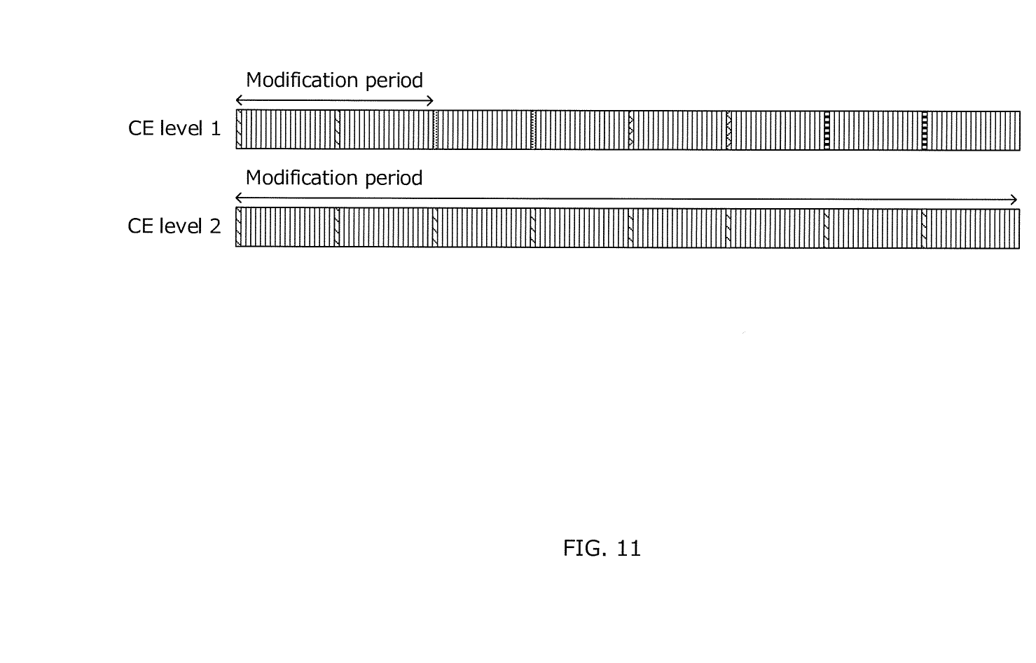

In the examples shown in FIG. 11, the subframes to transmit M-SIBs have a fixed cycle. For example, an M-SIB-transmitting subframe appears every 20 ms.

Referring to the example shown in FIG. 11, when the coverage enhancement (CE) level is 1, the repetition factor is 2, and the modification period is 40 ms. when the CE level is 2, the repetition factor is 8, and the modification period is 160 ms. When the CE level is 1, the repetition factor is small, and, although a time diversity effect cannot be gained, the modification period can be minimized. When the CE level is 2, the repetition factor is large, and, although a time diversity effect can be achieved, the modification period becomes very long. In this case, an MTC terminal needs to learn the modification period or the repetition factor from a broadcast signal and so on.

When the cycle of M-SIB-transmitting subframes is fixed, although it is possible to increase the repetition factor and gain a time diversity effect when the CE level is large, on the other hand, the modification period becomes very long, which leads to a delay.

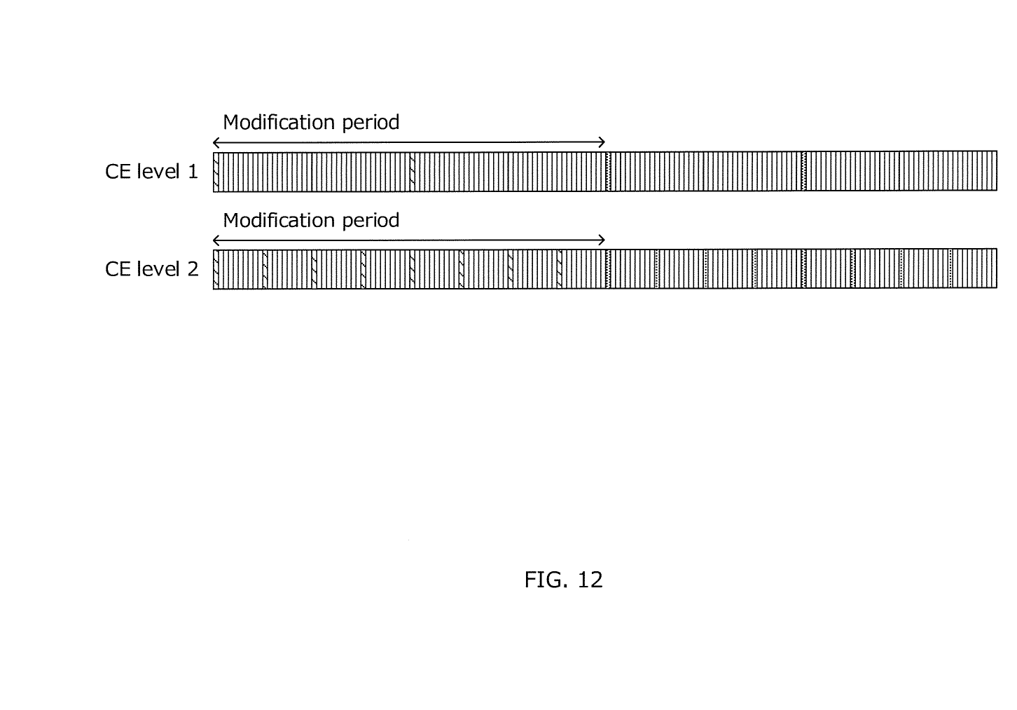

In the example shown in FIG. 12, modification period is fixed regardless of the repetition factor. The duration of modification is determined by the maximum repetition factor, and therefore the modification period becomes long as a result. In this case, the modification period is constant regardless of the CE level, so that an equivalent time diversity effect can be gained regardless of the CE level. Note that, although the delays can be reduced by shortening the modification period, M-SIBs are transmitted more frequently when the CE level increases, which results in increased overhead. An MTC terminal receives M-SIBs by presuming the maximum repetition factor, and therefore does not need to know the repetition factor. However, letting an MTC terminal know the repetition factor is effective to reduce the power consumption.

In the examples shown in FIG. 12, the modification period is fixed to 80 ms both when the CE level is 1 and when the CE level is 2. This modification period is determined in advance, considering the maximum coverage. When the CE level is 1, the number of repetitions in one cycle is 2. When the CE level is 2, the number of repetitions in one cycle is 8.

If a fixed modification period is applied, an MTC terminal has to take a long time to receive an M-SIB even if the CE level small. Although the MTC terminal does not have to know the repetition factor, in this case, the MTC terminal receives an M-SIB by presuming the maximum repetition factor, and this results in increased power consumption.

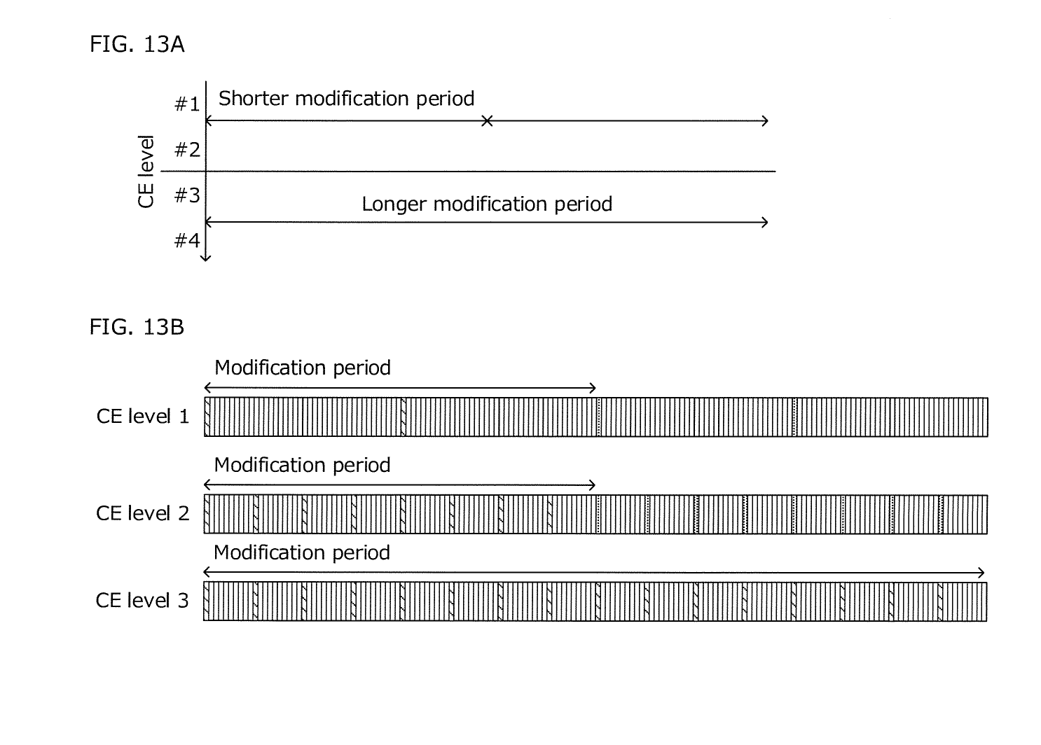

In the examples shown in FIG. 13, 2 or more modification periods are defined. As shown in FIG. 13A, when the repetition factor is smaller (CE levels 1 and 2), shorter modification periods are used. When the repetition factor is larger (CE levels 3 and 4), long modification periods are used. These modification periods are all fixed. In this way, characteristics of this example include that the total number of CE levels and the total number of modification periods are different, and that one or more CE levels are configured in one modification period.

It is thus possible to gain a time diversity effect by configuring the modification period slightly long for relatively small CE levels (for example, CE levels 1 and 2), and, meanwhile, prevent an increase in delay by using adequate modification periods. Although, by configuring the modification period long for relatively large CE levels (for example, CE levels 3 and 4), delay is tolerated, it is possible to prevent the overhead of M-SIBs from increasing. In this case, an MTC terminal needs to know the modification period or the repetition factor from a broadcast signal and so on. The switching of the modification period based on the CE level may be stipulated in the specification.

As shown in FIG. 13B, when the modification period is short (for example, 40 ms), the number of repetition is configured to vary per CE level. When the CE level is 1, the number of repetitions in one cycle is 2. When the CE level is 2, the number of repetitions in one cycle is 8. Likewise, when the modification period is long (for example, 80 ms), too, the number of repetition is configured to vary per CE level. In the example shown in FIG. 13B, when the CE level is 3, the number of repetitions in one cycle is 16.

By configuring two or more modification periods, it becomes possible to apply adequate modification periods and repetition factors depending on CE levels.

### Structure of Radio Communication System

Now, the structure of the radio communication system according to the present embodiment will be described below. In this radio communication system, the radio communication methods according to the embodiments of the present invention are employed. Here, although MTC terminals will be shown as examples of user terminals in which the bandwidth to use is limited to reduced bandwidths, the present invention is by no means limited to MTC terminals.

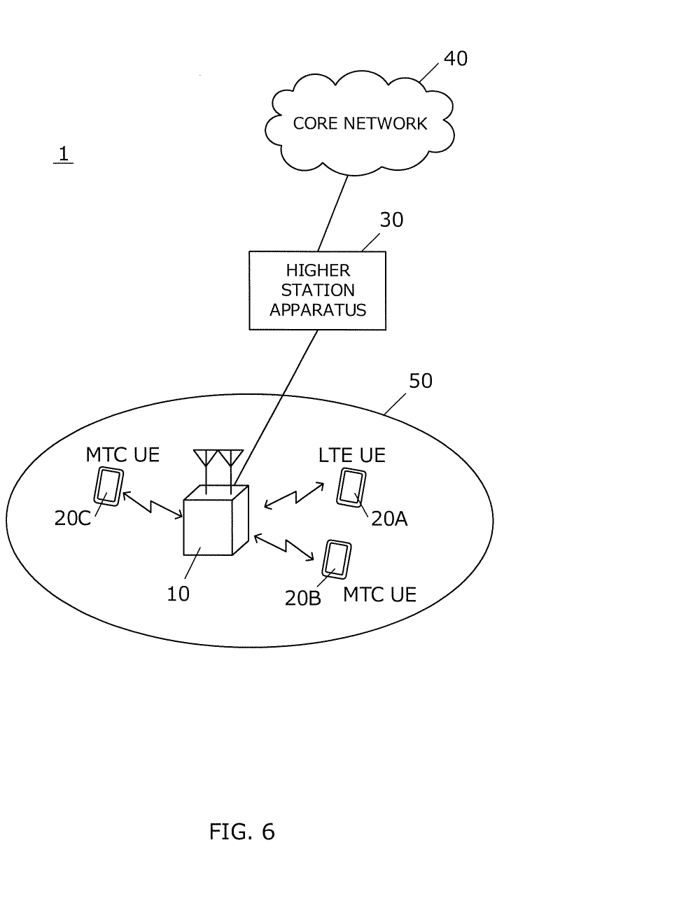

FIG. 6 is a diagram to show an example schematic structure of the radio communication system according to the present embodiment. The radio communication system 1 shown in FIG. 6 is an example of employing an LTE system in the network domain of a machine communication system. The radio communication system 1 can adopt one or both of carrier aggregation (CA) and dual connectivity (DC) to group a plurality of fundamental frequency blocks (component carriers) into one, where the LTE system bandwidth constitutes one unit. Also, although, in this LTE system, the system bandwidth is configured to maximum 20 MHz in both the downlink and the uplink, this configuration is by no means limiting. The radio communication system 1 may be referred to as “SUPER 3G,” “LTE-A” (LTE-Advanced), “IMT-Advanced,” “4G,” “5G,” “FRA” (Future Radio Access) and so on.

As shown in FIG. 6, the radio communication system 1 is comprised of a radio base station 10 and a plurality of user terminals 20A, 20B and 20C that are connected with the radio base station 10. The radio base station 10 is connected with a higher station apparatus 30, and connected with a core network 40 via the higher station apparatus 30. The higher station apparatus 30 may be, for example, an access gateway apparatus, a radio network controller (RNC), a mobility management entity (MME) and so on, but is by no means limited to these.

A plurality of user terminal 20A, 20B and 20C can communicate with the radio base station 10 in a cell 50. For example, the user terminal 20A (hereinafter referred to as an “LTE terminal”) is a terminal that supports LTE (up to Rel. 10) or LTE-A (including Rel. 10 and later versions). The user terminals 20B and 20C are MTC terminals that serve as communication devices in machine communication systems. Hereinafter the user terminals 20A, 20B and 20C will be simply referred to as “user terminals 20,” unless specified otherwise.

The MTC terminals 20B and 20C are terminals that support various communication schemes including LTE and LTE-A, and are by no means limited to stationary communication terminals such electric meters, gas meters, vending machines and so on, and can be mobile communication terminals such as vehicles. The user terminals 20 may communicate with other user terminals directly, or communicate with other user terminals via the radio base station 10.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bandwidths (subcarriers) and mapping data to each subcarrier. SC-FDMA is a single-carrier communication scheme to mitigate interference between terminals by dividing the system bandwidth into bandwidths formed with one or continuous resource blocks per terminal, and allowing a plurality of terminals to use mutually different bandwidths. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a downlink control channel (PDCCH: Physical Downlink Control CHannel and/or EPDCCH: Enhanced Physical Downlink Control CHannel), a broadcast channel (PBCH: Physical Broadcast CHannel) and so on are used as downlink channels. User data, higher layer control information and predetermined SIBs (System Information Blocks) are communicated in the PDSCH. Downlink control information (DCI) is communicated using the PDCCH and/or the EPDCCH. The MIB (Master Information Block) and so on are communicated in the PBCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel) and so on are used as uplink channels. User data and higher layer control information are communicated by the PUSCH.

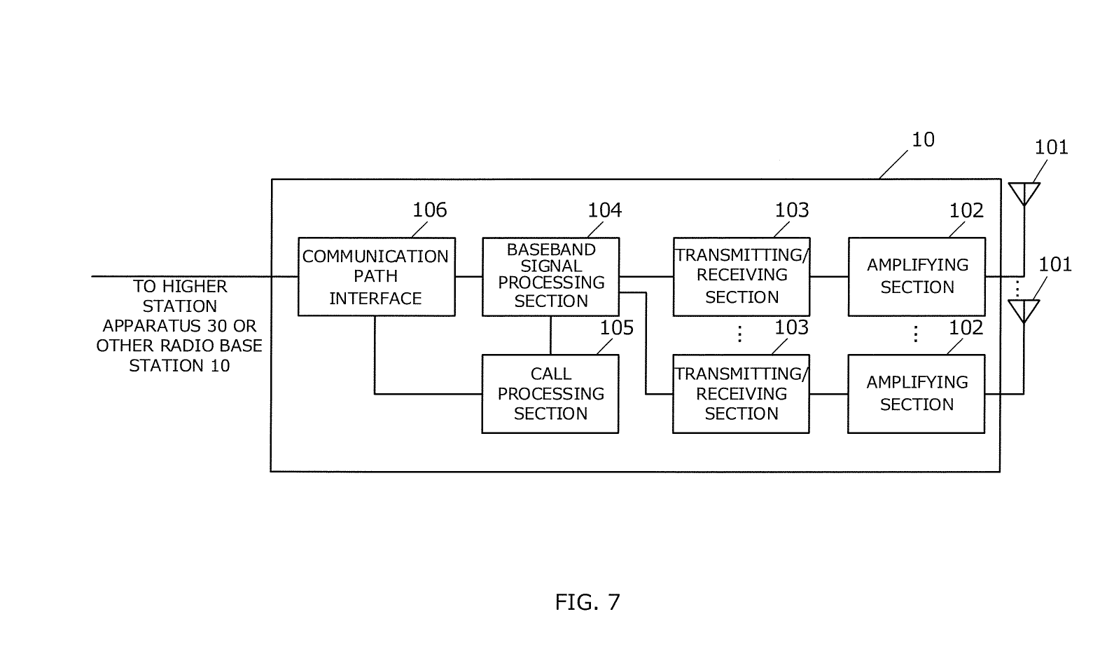

FIG. 7 is a diagram to explain an overall structure of a radio base station 10 according to the present embodiment. As shown in FIG. 7, the radio base station 10 has a plurality of transmitting/receiving antennas 101 for MIMO (Multiple Input Multiple Output) communication, amplifying sections 102, transmitting/receiving sections (transmitting sections and receiving sections) 103, a baseband signal processing section 104, a call processing section 105 and a communication path interface 106.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Each transmitting/receiving section 103 converts downlink signals that are pre-coded and output from the baseband signal processing section 104 on a per antenna basis, into a radio frequency bandwidth. The radio frequency signals subjected to frequency conversion in the transmitting/receiving sections 103 are amplified in the amplifying sections 102, and transmitted from the transmitting/receiving antennas 101.

The transmitting/receiving sections 103 can transmit, for example, system information (the MIB, SIBs, etc.). For the transmitting/receiving sections 103, transmitters/receivers, transmitting/receiving circuits or transmitting/receiving devices that can be described based on common understanding of the technical field to which the present invention pertains can be used.

As for uplink signals, radio frequency signals that are received in the transmitting/receiving antennas 101 are each amplified in the amplifying sections 102, converted into baseband signals through frequency conversion in each transmitting/receiving section 103, and input into the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface 106 transmits and receives signals to and from neighboring radio base stations (backhaul signaling) via an inter-base station interface (for example, optical fiber, the X2 interface, etc.). Alternatively, the communication path interface section 106 transmits and receives signals to and from the higher station apparatus 30 via a predetermined interface.

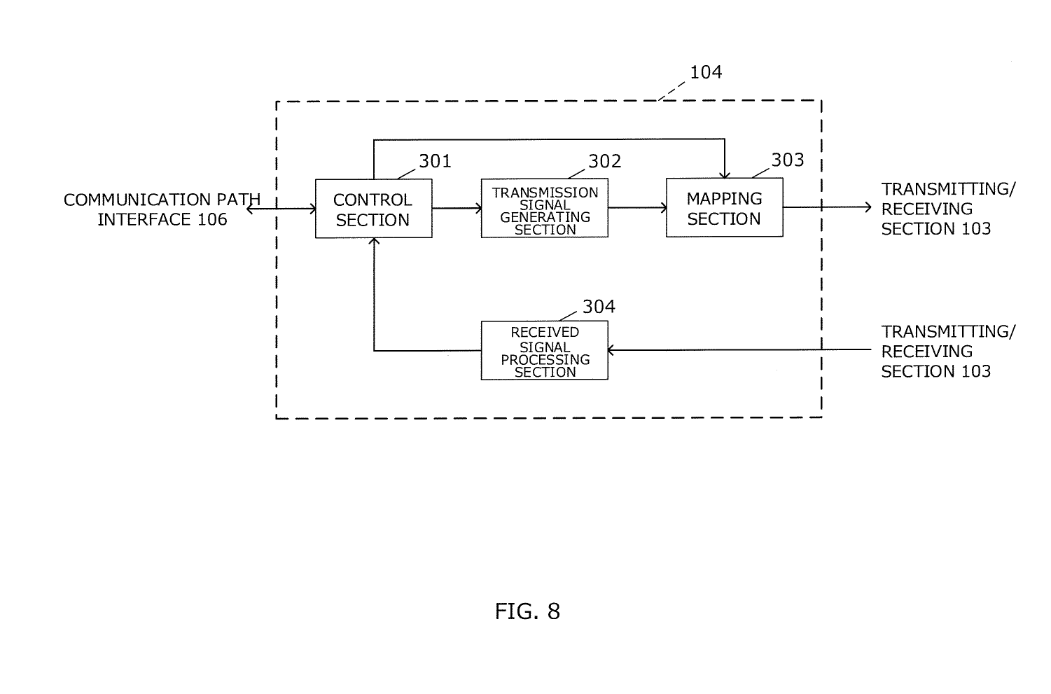

FIG. 8 is a diagram to show a principle functional structure of the baseband signal processing section 104 provided in the radio base station 10 according to the present embodiment. Although FIG. 8 primarily shows functional blocks that pertain to characteristic parts of the present embodiment, the radio base station 10 has other functional blocks that are necessary for radio communication as well. As shown in FIG. 8, the baseband signal processing section 104 provided in the radio base station 10 is comprised at least of a control section 301, a transmission signal generating section 302, a mapping section 303 and a received signal processing section 304.

The control section 301 controls the scheduling of downlink user data that is transmitted in the PDSCH, downlink control information that is communicated in one or both of the PDCCH and the enhanced PDCCH (EPDCCH), downlink reference signals and so on. Also, the control section 301 controls the scheduling (allocation control) of RA preambles communicated in the PRACH, uplink data that is communicated in the PUSCH, uplink control information that is communicated in the PUCCH or the PUSCH, and uplink reference signals. Information about the allocation control of uplink signals (uplink control signals, uplink user data, etc.) is reported to the user terminals 20 by using downlink control signals (DCI).

The control section 301 controls the allocation of radio resources to downlink signals and uplink signals based on command information from the higher station apparatus 30, feedback information from each user terminal 20 and so on. That is, the control section 301 functions as a scheduler. For the control section 301, a controller, a control circuit or a control device that can be described based on common understanding of the technical field to which the present invention pertains can be used.

The transmission signal generating section 302 generates downlink signals based on commands from the control section 301 and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on.

For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to predetermined reduced-bandwidth radio resources (for example, maximum 6 resource blocks) based on commands from the control section 301, and outputs these to the transmitting/receiving sections 103.

For the mapping section 303, a mapper, a mapping circuit or a mapping device that can be described based on common understanding of the technical field to which the present invention pertains can be used.

The received signal processing section 304 performs the receiving processes (for example, demapping, demodulation, decoding and so on) of the UL signals that are transmitted from the user terminals (for example, delivery acknowledgement signals (HARQ-ACKs), data signals that are transmitted in the PUSCH, random access preambles that are transmitted in the PRACH, and so on). The processing results are output to the control section 301.

By using the received signals, the received signal processing section 304 may measure the received power (for example, RSRP (Reference Signal Received Power)), the received quality (for example, RSRQ (Reference Signal Received Quality)), channel states and so on. The measurement results may be output to the control section 301.

The received signal processing section 304 can be constituted by a signal processor, a signal processing circuit or a signal processing device, and a measurer, a measurement circuit or a measurement device that can be described based on common understanding of the technical field to which the present invention pertains.

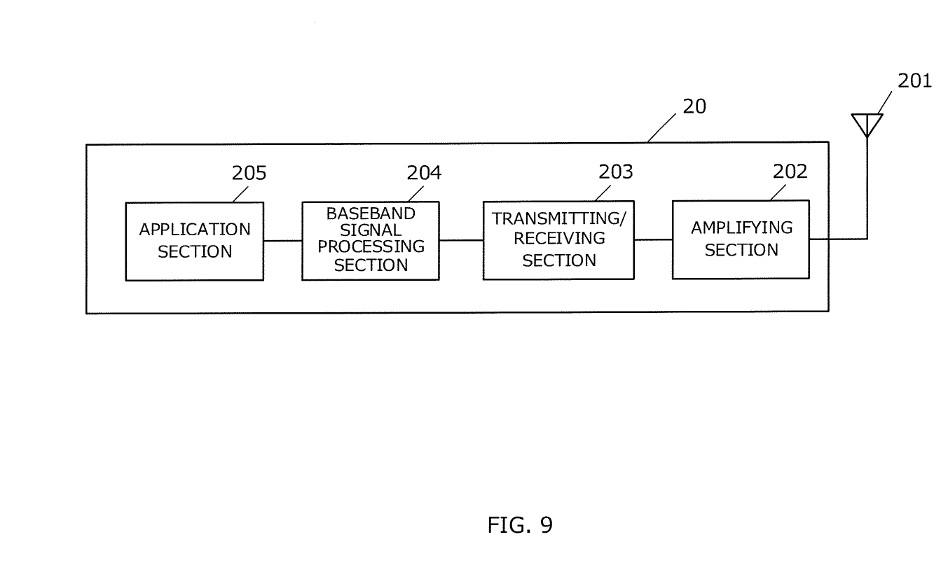

FIG. 9 is a diagram to show an overall structure of a user terminal 20 according to the present embodiment. Note that, although the details will not be described here, normal LTE terminals may operate and act as MTC terminals. As shown in FIG. 9, the user terminal 20 has a transmitting/receiving antenna 201, an amplifying section 202, a transmitting/receiving section (transmitting section and receiving section) 203, a baseband signal processing section 204 and an application section 205. Also, the user terminal 20 may have a plurality of transmitting/receiving antennas 201, amplifying sections 202, transmitting/receiving sections 203 and so on.

A radio frequency signal that is received the transmitting/receiving antenna 201 is amplified in the amplifying section 202 and converted into the baseband signal through frequency conversion in the transmitting/receiving section 203. This baseband signal is subjected to an FFT process, error correction decoding, a retransmission control receiving process and so on in the baseband signal processing section 204. In this downlink data, downlink user data is forwarded to the application section 205. The application section 205 performs processes related to higher layers above the physical layer and the MAC layer, and so on. Also, in the downlink data, broadcast information is also forwarded to the application section 205. For the transmitting/receiving section 203, a transmitter/receiver, a transmitting/receiving circuit or a transmitting/receiving device that can be described based on common understanding of the technical field to which the present invention pertains can be used.

The transmitting/receiving section 203 can receive, for example, system information (the MIB, SIBs, etc.).

Uplink user data is input from the application section 205 to the baseband signal processing section 204. In the baseband signal processing section 204, a retransmission control (HARQ) transmission process, channel coding, precoding, a discrete Fourier transform (DFT) process, an inverse fast Fourier transform (IFFT) process and so on are performed, and the result is forwarded to transmitting/receiving section 203. The baseband signal that is output from the baseband signal processing section 204 is converted into a radio frequency band in the transmitting/receiving section 203. After that, the amplifying section 202 amplifies the radio frequency signal having been subjected to frequency conversion, and transmits the resulting signal from the transmitting/receiving antenna 201.

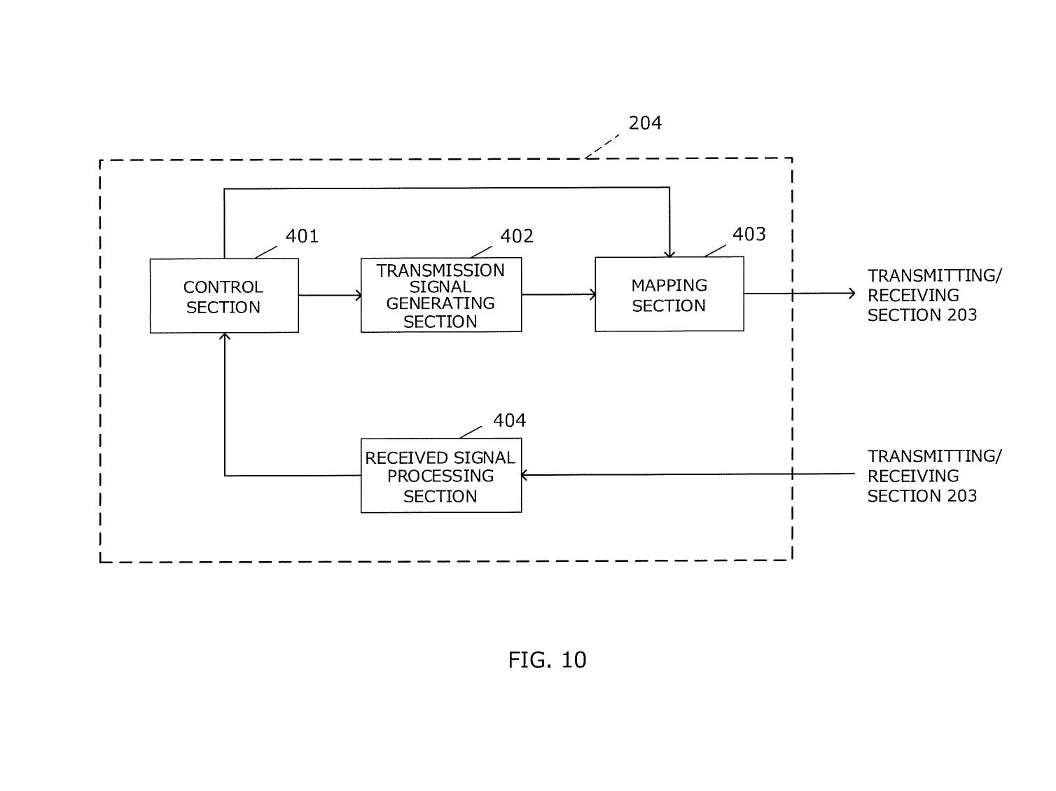

FIG. 10 is a diagram to show a principle functional structure of the baseband signal processing section 204 provided in the user terminal 20. Note that, although FIG. 10 primarily shows functional blocks that pertain to characteristic parts of the present embodiment, the user terminal 20 has other functional blocks that are necessary for radio communication as well. As shown in FIG. 10, the baseband signal processing section 204 provided in the user terminal 20 is comprised at least of a control section 401, a transmission signal generating section 402, a mapping section 403 and a received signal processing section 404.

For example, the control section 401 acquires the downlink control signals (signals transmitted in the PDCCH/EPDCCH) and downlink data signals (signals transmitted in the PDSCH) transmitted from the radio base station 10, from the received signal processing section 404. The control section 401 controls the generation of uplink control signals (for example, delivery acknowledgement signals (HARQ-ACKs) and so on) and uplink data signals based on the downlink control signals, the results of deciding whether or not retransmission control is necessary for the downlink data signals, and so on. To be more specific, the control section 401 controls the transmission signal generating section 402 and the mapping section 403.

The control section 401 acquires transmission information for M-SIBx, including repetition factors, from M-SIB1. For the control section 401, a controller, a control circuit or a control device that can be described based on common understanding of the technical field to which the present invention pertains can be used.

The transmission signal generating section 402 generates UL signals based on commands from the control section 401, and outputs these signals to the mapping section 403. For example, the transmission signal generating section 402 generates uplink control signals such as delivery acknowledgement signals (HARQ-ACKs) and channel state information (CSI) based on commands from the control section 401. Also, the transmission signal generating section 402 generates uplink data signals based on commands from the control section 401. For example, when a UL grant is included in a downlink control signal that is reported from the radio base station 10, the control section 401 commands the transmission signal generating section 402 to generate an uplink data signal.

For the uplink control signal generating section 402, a signal generator or a signal generating circuit that can be described based on common understanding of the technical field to which the present invention pertains can be used.

The mapping section 403 maps the uplink signals generated in the transmission signal generating section 402 to radio resources based on commands from the control section 401, and outputs these to the transmitting/receiving section 203. For the mapping section 403, mapper, a mapping circuit or a mapping device that can be described based on common understanding of the technical field to which the present invention pertains can be used.

The received signal processing section 404 performs the receiving processes (for example, demapping, demodulation, decoding and so on) of DL signals (for example, downlink control signals transmitted from the radio base station, downlink data signals transmitted in the PDSCH, and so on). The received signal processing section 404 outputs the information received from the radio base station 10, to the control section 401. The received signal processing section 404 outputs, for example, broadcast information, system information, paging information, RRC signaling, DCI and so on, to the control section 401.

Also, the received signal processing section 404 may measure the received power (RSRP), the received quality (RSRQ) and channel states, by using the received signals. The measurement results may be output to the control section 401.

The received signal processing section 404 can be constituted by a signal processor, a signal processing circuit or a signal processing device, and a measurer, a measurement circuit or a measurement device that can be described based on common understanding of the technical field to which the present invention pertains. The received signal processing section 404 can constitute the receiving section according to the present invention.

Note that the block diagrams that have been used to describe the above embodiment show blocks in function units. These functional blocks (components) may be implemented in arbitrary combinations of hardware and software. The means for implementing each functional block is not particularly limited. That is, each functional block may be implemented with one physically-integrated device, or may be implemented by connecting two or more physically-separate devices via radio or wire and using these multiple devices.

For example, part or all of the functions of radio base stations 10 and user terminals 20 may be implemented using hardware such as an ASIC (Application-Specific Integrated Circuit), a PLD (Programmable Logic Devices), an FPGA (Field Programmable Gate Array), and so on. The radio base stations 10 and user terminals 20 may be implemented with a computer device that includes a processor (CPU), a communication interface for connecting with networks, a memory and a computer-readable storage medium that stores programs.

The processor and the memory are connected with a bus for communicating information. The computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. The radio base stations 10 and user terminals 20 may include input devices such as input keys and output devices such as displays.

The functional structures of the radio base stations 10 and user terminals 20 may be implemented by using the above-described hardware, may be implemented by using software modules to be executed on the processor, or may be implemented by combining both of these. The processor controls the whole of the user terminals by running an operating system. The processor reads programs, software modules and data from the storage medium into the memory, and executes various types of processes. These programs have only to be programs that make a computer execute each operation that has been described with the above embodiments. For example, the control section 401 of the user terminals 20 may be stored in a memory and implemented by a control program that operates on the processor, and other functional blocks may be implemented likewise.

Note that the present invention is by no means limited to the above embodiments and can be carried out with various changes. The sizes and shapes illustrated in the accompanying drawings in relationship to the above embodiment are by no means limiting, and may be changed as appropriate within the scope of optimizing the effects of the present invention. Besides, implementations with various appropriate changes may be possible without departing from the scope of the object of the present invention.

The disclosures of Japanese Patent Application No. 2015-014607, filed on Jan. 28, 2015, and Japanese Patent Application No. 2015-024613, filed on Feb. 10, 2015, including the specifications, drawings and abstracts, are incorporated herein by reference in their entirety.

1. A user terminal, in which a bandwidth to use is limited to a partial reduced bandwidth in a system bandwidth, the user terminal comprising:
a receiving section that receives first system information and second system information; and
a control section that acquires transmission information, which includes a repetition factor for the second system information, from the first system information,
wherein the receiving section receives the second system information based on the transmission information.

2. The user terminal according to claim 1, wherein:
the receiving section receives a physical broadcast channel (PBCH), and, based on transmission information that is acquired from the PBCH in the control section and that includes a repetition factor for the first system information, acquires the first system information.

3. The user terminal according to claim 1, wherein the receiving section receives the first system information, which is transmitted in a fixed resource following a predetermined timing.

4. The user terminal according to claim 1, wherein the receiving section detects a common search space, and receives the first system information indicated in the common search space.

5. The user terminal according to claim 4, wherein a DCI format 1A/1C scrambled by an SI-RNTI represents transmission information, which is transmitted in a downlink shared channel and which includes a repetition factor for the first system information.

6. The user terminal according to claim 4, wherein:
the receiving section detects the common search space and receives the second system information indicated in the common search space; and
a repetition factor for a subframe for monitoring the common search space is fixed, included in the first system information or associated with the first system information.

7. The user terminal according to claim 1, wherein the repetition factor for the second system information is associated with the repetition factor for the first system information.

8. The user terminal according to claim 1, wherein:
the second system information is transmitted by using a transmission pattern of a different repetition factor in every predetermined cycle; and
the receiving section selects one transmission pattern based on received quality of a downlink reference signal and receives the second system information.

9. The user terminal according to claim 1, wherein:
repetition factors and modification periods for the first system information and the second system information are defined based on enhancement levels;
a first modification period and a second modification period, which are fixed, are defined as the modification periods;
the first modification period is used for a smaller repetition factor; and
the second modification period is used for a larger repetition factor.

10. A radio communication method for a user terminal, in which a bandwidth to use is limited to a reduced bandwidth in a system bandwidth, the radio communication method comprising the steps of:
receiving first system information and second system information;
acquiring transmission information, which includes a repetition factor for the second system information, from the first system information; and
receiving the second system information based on the transmission information.
